(19) United States
(12) Patent Application Publication
(10) Pub. No.: US 2012/0030618 A1
(43) Pub. Date: Feb. 2, 2012

(54) SYSTEMS AND METHODS FOR ASSIGNING ATTRIBUTES TO A PLURALITY OF SAMPLES

(75) Inventors: Harrison Leong, San Francisco, CA (US); Ruoyun Wu, Singapore (SG); Thiam Chye Lee, Singapore (SG)

(73) Assignee: LIFE TECHNOLOGIES CORPORATION, Carlsbad, CA (US)

(21) Appl. No.: 13/179,191

(22) Filed: Jul. 8, 2011

Related U.S. Application Data
(60) Provisional application No. 61/362,636, filed on Jul. 8, 2010.

(51) Int. Cl. G06F 3/048

(52) U.S. Cl. 715/810

(57) ABSTRACT

Systems and methods for assigning attributes to a plurality of samples are provided. An exemplary system includes an instrument configured to perform an experiment on a plurality of samples in a multi-sample support device and to produce a plurality of measured values. The system further includes a computer system in communication with the instrument. The computer system is configured to receive the plurality of measured values from the instrument, store the plurality of measured values in a memory configured as a grid of cells representing the grid of the multi-sample support device, display the grid of cells in a graphical user interface, receive a selected cell from the graphical user interface, receive two or more attribute values for the selected cell from the graphical user interface, and store the two or more assigned attribute values along with a measured value of the selected cell in the memory configured as a grid of cells.

### CROSS-REFERENCE TO RELATED APPLICATIONS

This application claims the benefit of priority of U.S. Provisional Application No. 61/362,636, filed Jul. 8, 2010, which is incorporated herein by reference in its entirety.

### BACKGROUND

Generally, an experiment involving a large number of samples to be tested requires manual data entry of different attribute values corresponding to each sample. These experiments may include testing hundreds of samples. Inputting the attributes characterizing each sample is a tedious and time-consuming process. An example of a type of experiment that may involve a large number of samples is a real-time polymerase chain reaction (PCR) experiment performed by PCR instruments or thermal cyclers.

PCR instruments or thermal cyclers allow data to be collected during each thermal cycle. PCR data is typically collected at each thermal cycle using an optical system within the real-time PCR instrument that can detect electromagnetic radiation emitted by one or more probes attached to each deoxyribonucleic acid (DNA) sample analyzed by the real-time PCR instrument. The PCR data, therefore, includes one or more probe intensity values for each DNA sample at each thermal cycle or at each time associated with a thermal cycle.

Real-time PCR systems typically include a PCR instrument and an external computer system for controlling and/or monitoring the PCR instrument. The external computing system is used to create and modify the experiment attributes or parameters sent to the PCR instrument and/or to monitor the PCR instrument, assign post-experiment attributes, and analyze the PCR data received from the PCR instrument after the experiment. Although PCR systems enable the same or similar experiments to be run on multiple wells of a plate of DNA samples at the same time, pre and post-experiment attributes or parameters are typically assigned manually for each well. The process of inputting various attributes for every sample is tedious and time consuming.

### SUMMARY

According to various embodiments, systems and methods for assigning attributes to a plurality of samples are provided. An exemplary system includes an instrument configured to perform an experiment on a plurality of samples in a multi-sample support device and to produce a plurality of measured values. The system further includes a computer system in communication with the instrument. The computer system is configured to receive the plurality of measured values from the instrument, store the plurality of measured values in a memory configured as a grid of cells representing the grid of the multi-sample support device, display the grid of cells in a graphical user interface, receive a selected cell from the graphical user interface, receive two or more attribute values for the selected cell from the graphical user interface, and store the two or more assigned attribute values along with a measured value of the selected cell in the memory configured as a grid of cells.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a block diagram that illustrates a polymerase chain reaction (PCR) instrument, upon which embodiments of the present teachings may be implemented.

FIG. 3 is a block diagram that illustrates a real-time PCR instrument, upon which embodiments of the present teachings may be implemented.

FIG. 4 is an exemplary portion of a two-dimensional grid of cells of a graphical user interface (GUI) representing a two-dimensional grid of plate wells and showing a threshold cycle value (Ct value) for each cell, in accordance with various embodiments.

FIG. 5 is an exemplary popup window of a GUI of a system for adding custom attributes and defining enumerated series, in accordance with various embodiments.

FIG. 6 is an exemplary portion of a two-dimensional grid of cells of a GUI of a system representing a two-dimensional grid of plate wells and showing how multiple attribute values are added to a cell, in accordance with various embodiments.

FIG. 7 is an exemplary portion of a two-dimensional grid of cells of a GUI of a system representing a two-dimensional grid of plate wells and showing multiple attribute values for a cell, in accordance with various embodiments.

FIG. 8 is an exemplary worksheet window of a GUI of a system for specifying advanced setting for attributes, in accordance with various embodiments.

FIG. 9 is an exemplary portion of a two-dimensional grid of cells of a GUI of a system representing a two-dimensional grid of plate wells and showing the extension of attribute values from one cell to two other adjacent cells in a row, in accordance with various embodiments.

FIG. 10 is an exemplary portion of a two-dimensional grid of cells of a GUI of a system representing a two-dimensional grid of plate wells and showing the extension of attribute values from one cell to two other adjacent cells in a column, in accordance with various embodiments.

FIG. 11 is an exemplary portion of a two-dimensional grid of cells of a GUI of a system representing a two-dimensional grid of plate wells and showing the extension of attribute values from one cell to two other non adjacent cells in a row, in accordance with various embodiments.

FIG. 12 is an exemplary portion of a two-dimensional grid of cells of a GUI of a system representing a two-dimensional grid of plate wells and showing the extension of attribute values from four cells to four other adjacent cells, in accordance with various embodiments.

FIG. 13A is an exemplary worksheet window of a GUI of a system for specifying advanced setting for attributes, in accordance with various embodiments.

FIG. 13B is an exemplary worksheet window of a GUI of a system for specifying advanced setting for attributes, in accordance with various embodiments.

FIG. 14 is an exemplary plot of experimental average threshold values plotted as a function of “Input Quantity” attribute values, in accordance with various embodiments.

FIG. 15 is a diagram of a system for assigning attributes to a plurality of samples, in accordance with various embodiments.

FIG. 16 is an exemplary flowchart showing a method for assigning attributes to a plurality of samples, in accordance with various embodiments.

FIG. 17 is a schematic diagram of a system of distinct software modules that performs a method for assigning attributes to a plurality of samples, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DETAILED DESCRIPTION OF VARIOUS EMBODIMENTS

The methods and systems according to various embodiments described herein may be used in an application area where there are multiple discreet variables associated with a single entity for data analysis. According to various embodiments, some variable values may not all be entered manually by a system user. Although the following description pertains to user-defined sample support device setup using PCR systems, one skilled in the art can appreciate that the systems and methods described here can be applied to similar systems that employ high density sample support devices. A non-limiting example of such similar systems includes protein analysis systems, oligonucleotide array systems, sequencing systems, or any other system or instrument that performs experiments on a plurality of samples.

### Assignment of Attributes to Samples

As described above, although PCR systems enable the same or similar experiments to be run on multiple wells of a plate of DNA samples at the same time, pre and post-experiment attributes or parameters are typically assigned manually for each well. Consequently, identical or similar experiment attribute values are often entered tens or even hundreds of times for each plate of DNA samples.

In various embodiments, a graphical user interface (GUI) is used to define a list of named attributes to be associated with all wells of all plates used to hold samples. For example, the plurality of wells of plates in the PCR system.

In various embodiments, a GUI is used to define the fill-in behavior of each attribute. This fill-in behavior can include a copy function, an enumerated series, an arithmetic series, a geometric series, or any series based on a multi-variate function of one or more named series or one or more of the attributes in the grid, for example. The fill-in behavior may be automatically selected for some or all of the cells according to various embodiments. The fill-in behavior may also be a user-defined function. The fill-in behavior can be extended to other functions and functions between attribute values in other wells in the same or other plates.

According to various embodiments described herein, the GUI is configured to facilitate locating a cell of interest in a representation of the plurality of samples, allowing a user to edit or enter in attribute values.

In various embodiments, a GUI is used to assign values to the attributes associated with wells of a multi-well sample support device or plate of a PCR system, for example. This GUI facilitates the assignment of values to one or more different attributes associated with each well of a plate. This GUI also allows attribute values to be assigned to one or more wells in a row of wells, a column of wells, or an array of rows and columns of wells at the same time. As a result, the GUI automates the assignment of attribute values to plate wells in much the same way as multichannel pipettors automate the transfer of liquids to plate wells.

In various embodiments, a GUI is used to assign attributes and/or attribute values to a two-dimensional grid of cells representing the two-dimensional grid of plate wells after a PCR experiment. In various alternative embodiments, a GUI is used to assign attributes and/or attribute values to a multi-dimensional grid of cells for a plurality of samples. In a PCR experiment, the GUI may represent the two-dimensional grid of plate wells before a PCR experiment. However, the grid of cells may be one, two, or more dimensions in various embodiments.

If the GUI is used to assign attribute values after an experiment, the assigned attribute values are associated with an experimental value obtained as a result of processing a sample contained in a well.

For example, a PCR experiment is performed on a multi-plate well in a PCR instrument. The PCR instrument measures values for each well that can include, but are not limited to, fluorescence or temperature. The PCR instrument or an external computer system of the PCR system calculates experimental values from the measured values for each well that can include, but are not limited to, average threshold cycle value (Ct value) or melt temperature.

The PCR system loads the experimental values for each well of the plate into a two-dimensional grid of cells representing the two-dimensional grid of plate wells. The GUI of the PCR system allows one or more attributes to be added to or deleted from each cell of the two-dimensional grid of cells. The GUI of the PCR system also allows values of each attribute to be set for, modified in, or deleted from each cell of the two-dimensional grid of cells. The GUI is displayed by an external computer system of the PCR system, for example. In various alternative embodiments, the GUI is displayed by the user interface of the PCR instrument.

According to embodiments described herein, the system can use the experimental values and the attributes to further analyze the experiment. For example, the GUI of the PCR system allows a type of analysis to be selected. The PCR system performs the analysis based on one or more of the attribute values. Finally, the GUI of the PCR system displays the results of the analysis. These results can be sorted or grouped, for example, based on one or more of the attribute values.

### Example

In one example, various embodiments may be implemented in the context of identifying storage media for proteins. Identifying stored proteins for examination at a future time may be necessary in a wide variety of contexts. For example, specimens collected for medical purposes might need to be transferred to laboratories with the means to analyze them. Proteins may need to be held until resources are available to analyze them. Additionally, proteins may need to be preserved for study at a future date or held as possible evidence in future legal proceedings.

The media in which protein is stored can have a large influence on the time it takes before the protein begins to degrade. In general, the storage medium may need to be customized to maximize stability of the stored protein. Interactions between storage media and the particular protein in question may influence the behavior of the protein. A medium may be chosen based on the melting temperature of a protein, the temperature at which the protein begins to unravel. Melting temperature can be found by gradually heating the protein and storage medium and using a special dye that sticks to loci of the protein that are exposed as the protein unravels. (The dye fluoresces only when it is stuck to these special loci.)

Scientists in search of superior storage media might test hundreds of media variations, such as salt concentrations, different kinds of salts, concentrations and types of other additives, and different kinds of solvents. The melting temperature for each of these variations may be determined. To understand how various factors influence protein stability, scientists may want to sort results according to the variations in the storage media. By doing this, meaningful patterns in the data can be revealed. For example, it might be discovered that protein stability gradually increases as salt concentration increases or that the type of solvent used has a much greater influence on the melting temperature. These discoveries, in turn, can lead scientists to examine more effective combinations of factors to improve protein storage stability.

As such, a multi-attribute spreadsheet according to various embodiments provides a method and system to quickly specify the layout of these variations in the data being collected.

### Computer-Implemented System

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on non-transitory computer-readable media. Some other processes can be implemented using analog circuitry, as is well known to one of ordinary skill in the art. Additionally, memory or other storage, as well as communication components, may be employed in embodiments of the invention.

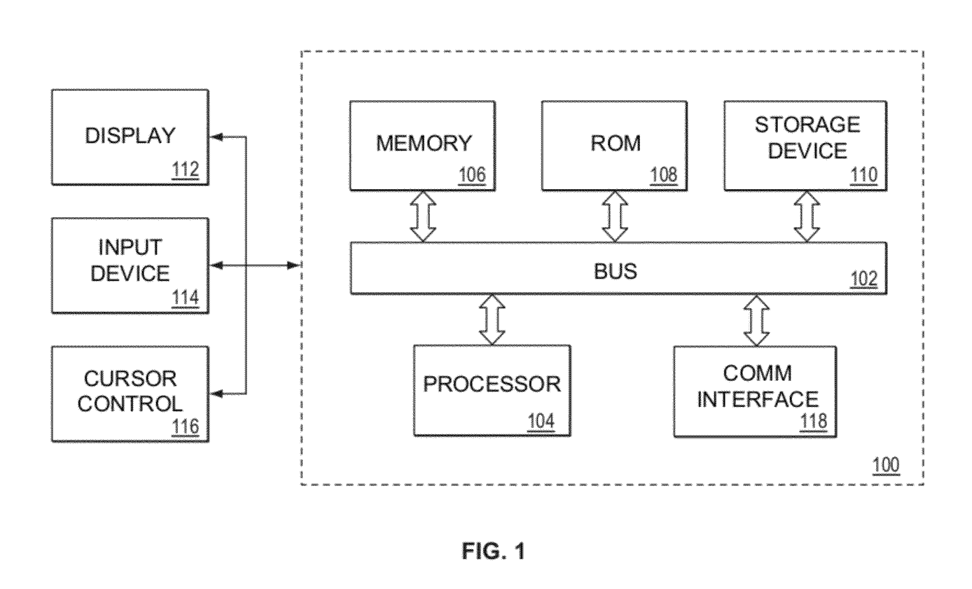

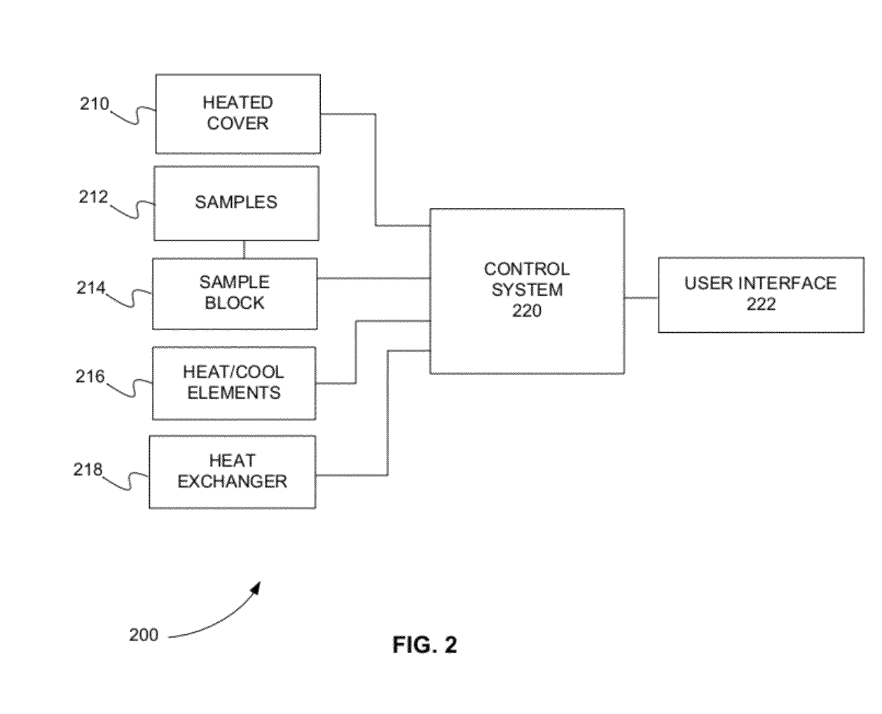

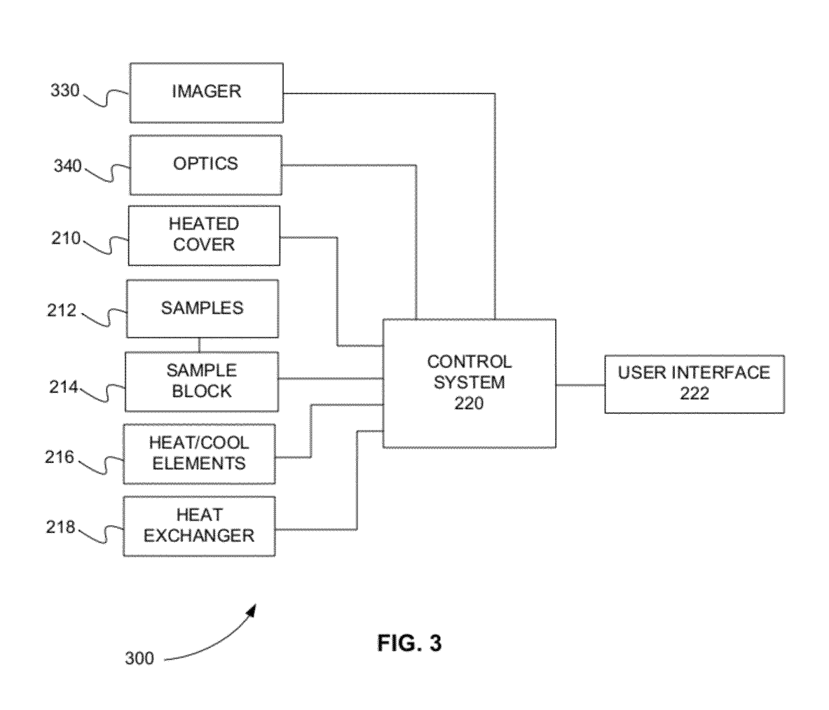

FIG. 1 is a block diagram that illustrates a computer system 100 that may be employed to carry out processing functionality, according to various embodiments. Instruments to perform experiments may be connected to the exemplary computing system 100. According to various embodiments, the instruments that may be utilized are a thermal cycler system 200 of FIG. 2 or a thermal cycler system 300 of FIG. 3 may utilize. Computing system 100 can include one or more processors, such as a processor 104. Processor 104 can be implemented using a general or special purpose processing engine such as, for example, a microprocessor, controller or other control logic. In this example, processor 104 is connected to a bus 102 or other communication medium.

Further, it should be appreciated that a computing system 100 of FIG. 1 may be embodied in any of a number of forms, such as a rack-mounted computer, mainframe, supercomputer, server, client, a desktop computer, a laptop computer, a tablet computer, hand-held computing device (e.g., PDA, cell phone, smart phone, palmtop, etc.), cluster grid, netbook, embedded systems, or any other type of special or general purpose computing device as may be desirable or appropriate for a given application or environment. Additionally, a computing system 100 can include a conventional network system including a client/server environment and one or more database servers, or integration with LIS/LIMS infrastructure. A number of conventional network systems, including a local area network (LAN) or a wide area network (WAN), and including wireless and/or wired components, are known in the art. Additionally, client/server environments, database servers, and networks are well documented in the art.

Computing system 100 may include bus 102 or other communication mechanism for communicating information, and processor 104 coupled with bus 102 for processing information.

Computing system 100 also includes a memory 106, which can be a random access memory (RAM) or other dynamic memory, coupled to bus 102 for storing instructions to be executed by processor 104. Memory 106 also may be used for storing temporary variables or other intermediate information during execution of instructions to be executed by processor 104. Computing system 100 further includes a read only memory (ROM) 108 or other static storage device coupled to bus 102 for storing static information and instructions for processor 104.

Computing system 100 may also include a storage device 110, such as a magnetic disk, optical disk, or solid state drive (SSD) is provided and coupled to bus 102 for storing information and instructions. Storage device 110 may include a media drive and a removable storage interface. A media drive may include a drive or other mechanism to support fixed or removable storage media, such as a hard disk drive, a floppy disk drive, a magnetic tape drive, an optical disk drive, a CD or DVD drive (R or RW), flash drive, or other removable or fixed media drive. As these examples illustrate, the storage media may include a computer-readable storage medium having stored therein particular computer software, instructions, or data.

In alternative embodiments, storage device 110 may include other similar instrumentalities for allowing computer programs or other instructions or data to be loaded into computing system 100. Such instrumentalities may include, for example, a removable storage unit and an interface, such as a program cartridge and cartridge interface, a removable memory (for example, a flash memory or other removable memory module) and memory slot, and other removable storage units and interfaces that allow software and data to be transferred from the storage device 110 to computing system 100.

Computing system 100 can also include a communications interface 118. Communications interface 118 can be used to allow software and data to be transferred between computing system 100 and external devices. Examples of communications interface 118 can include a modem, a network interface (such as an Ethernet or other NIC card), a communications port (such as for example, a USB port, a RS-232C serial port), a PCMCIA slot and card, Bluetooth, etc. Software and data transferred via communications interface 118 are in the form of signals which can be electronic, electromagnetic, optical or other signals capable of being received by communications interface 118. These signals may be transmitted and received by communications interface 118 via a channel such as a wireless medium, wire or cable, fiber optics, or other communications medium. Some examples of a channel include a phone line, a cellular phone link, an RF link, a network interface, a local or wide area network, and other communications channels.

Computing system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104, for example. An input device may also be a display, such as an LCD display, configured with touchscreen input capabilities. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A computing system 100 provides data processing and provides a level of confidence for such data. Consistent with certain implementations of embodiments of the present teachings, data processing and confidence values are provided by computing system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process states described herein. Alternatively hard-wired circuitry may be used in place of or in combination with software instructions to implement embodiments of the present teachings. Thus implementations of embodiments of the present teachings are not limited to any specific combination of hardware circuitry and software.

The term “computer-readable medium” and “computer program product” as used herein generally refers to any media that is involved in providing one or more sequences or one or more instructions to processor 104 for execution. Such instructions, generally referred to as “computer program code” (which may be grouped in the form of computer programs or other groupings), when executed, enable the computing system 100 to perform features or functions of embodiments of the present invention. These and other forms of non-transitory computer-readable media may take many forms, including but not limited to, non-volatile media, volatile media, and transmission media. Non-volatile media includes, for example, solid state, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on magnetic disk of a remote computer. The remote computer can load the instructions into its dynamic memory and send the instructions over a telephone line using a modem. A modem local to computing system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

### PCR Instruments

As mentioned above, an instrument that may be utilized according to various embodiments, but is not limited to, is a polymerase chain reaction (PCR) instrument. FIG. 2 is a block diagram that illustrates a PCR instrument 200, upon which embodiments of the present teachings may be implemented. PCR instrument 200 may include a heated cover 210 that is placed over a plurality of samples 212 contained in a sample support device (not shown). In various embodiments, a sample support device may be a glass or plastic slide with a plurality of sample regions, which sample regions have a cover between the sample regions and heated cover 210. Some examples of a sample support device may include, but are not limited to, a multi-well plate, such as a standard microtiter 96-well, a 384-well plate, or a microcard, or a substantially planar support, such as a glass or plastic slide. The sample regions in various embodiments of a sample support device may include depressions, indentations, ridges, and combinations thereof, patterned in regular or irregular arrays formed on the surface of the substrate. Various embodiments of PCR instruments include a sample block 214, elements for heating and cooling 216, a heat exchanger 218, control system 220, and user interface 222. Various embodiments of a thermal block assembly according to the present teachings comprise components 214-218 of PCR instrument 200 of FIG. 2.

FIG. 3 is a block diagram that illustrates a real-time PCR instrument 300, upon which embodiments of the present teachings may be implemented. Real-time PCR instrument 300 has the components of embodiments of PCR instrument 200 of FIG. 2, and additionally a detection system. In FIG. 3, a detection system may have an illumination source (not shown) that emits electromagnetic energy, a detector or imager 330, for receiving electromagnetic energy from samples 212 in a sample support device, and optics 340 used to guide the electromagnetic energy from each DNA sample to imager 330. For embodiments of PCR instrument 200 in FIG. 2 and real-time PCR instrument 300 in FIG. 3, control system 220, may be used to control the functions of the detection system, heated cover, and thermal block assembly. Control system 220 may be accessible to an end user through user interface 222 of PCR instrument 200 in FIG. 2 and real-time PCR instrument 300 in FIG. 3. Also a computer system 100, as depicted in FIG. 1, may serve as to provide the control the function of PCR instrument 200 in FIG. 2 and real-time PCR instrument 300 in FIG. 3, as well as the user interface function. Additionally, computer system 100 of FIG. 1 may provide data processing, display and report preparation functions. All such instrument control functions may be dedicated locally to the PCR instrument, or computer system 100 of FIG. 1 may provide remote control of part or all of the control, analysis, and reporting functions, as will be discussed in more detail subsequently.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

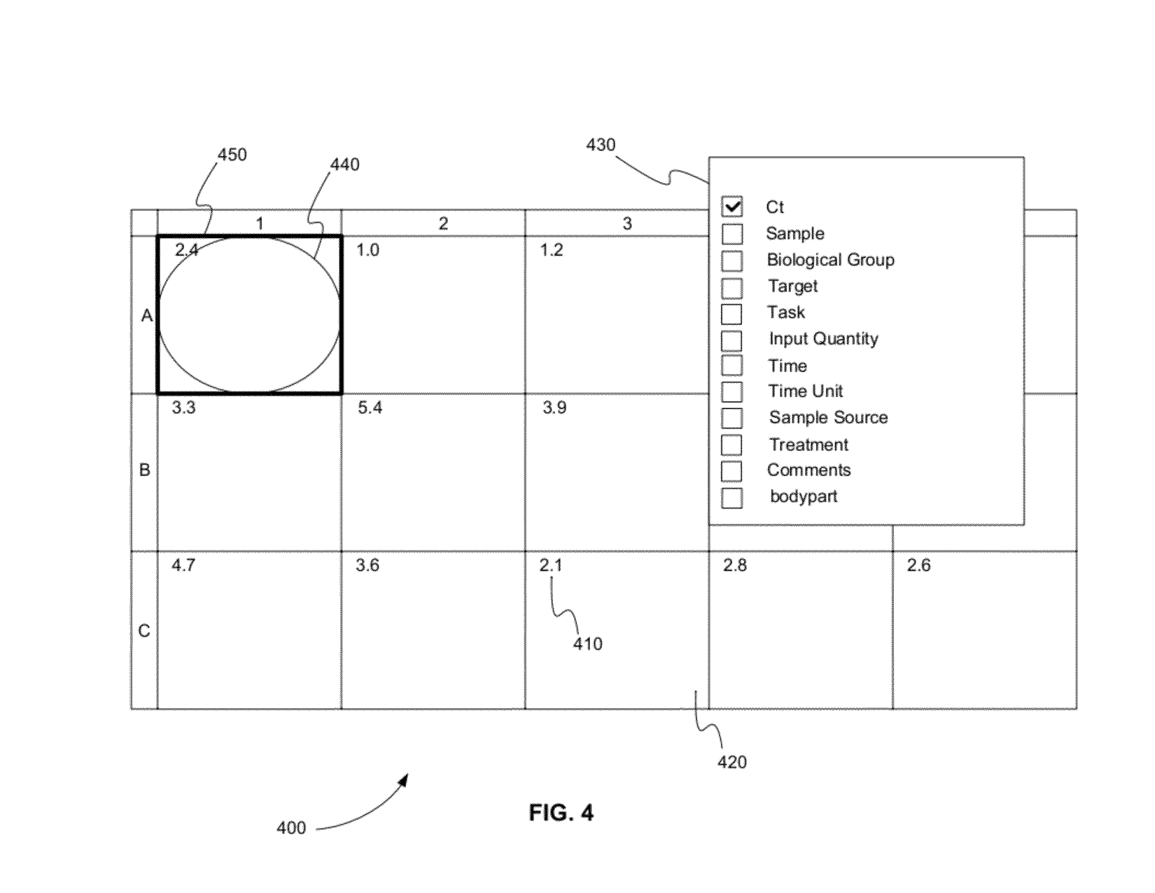

FIG. 4 is an exemplary portion of a two-dimensional grid of cells 400 of a GUI of a PCR system representing a two-dimensional grid of plate wells and showing a Ct value 410 for each cell 420, in accordance with various embodiments. One experimental variable, Ct, is shown as an example. A grid cell can contain more than one experimental variable. The Ct value 410 for each cell can alternatively be shown or not shown on two-dimensional grid of cells 400 through the use of checked pull down menu 430, for example.

Checked pull down menu 430 also includes examples of fixed and custom attributes. The cell attributes are unchecked in pull down menu 430. Fixed or default cell attributes can include, but are not limited to, “Sample”, “Biological Group”, “Target”, “Task”, “Input Quantity”, “Time”, “Time Unit”, “Sample Source”, “Treatment”, and “Comments”. Custom attributes, such as “bodypart,” can also be added to the PCR system and pull down menu 430 through the GUI of the PCR system.

Border 450 indicates that the cell located at row and column A1 is currently selected, for example. Circle 440 can be color coded according to the value of an attribute. For example, a GUI can provide the user with the ability to select which attribute to color code. One or more cells can be selected at a time. Adjacent, non-adjacent, or both adjacent and non-adjacent cells can be selected together. One skilled in the art can appreciate that input from a pointing device, a keyboard, any other input device, or any combination of input devices can be used to select cells of two-dimensional grid of cells 400.

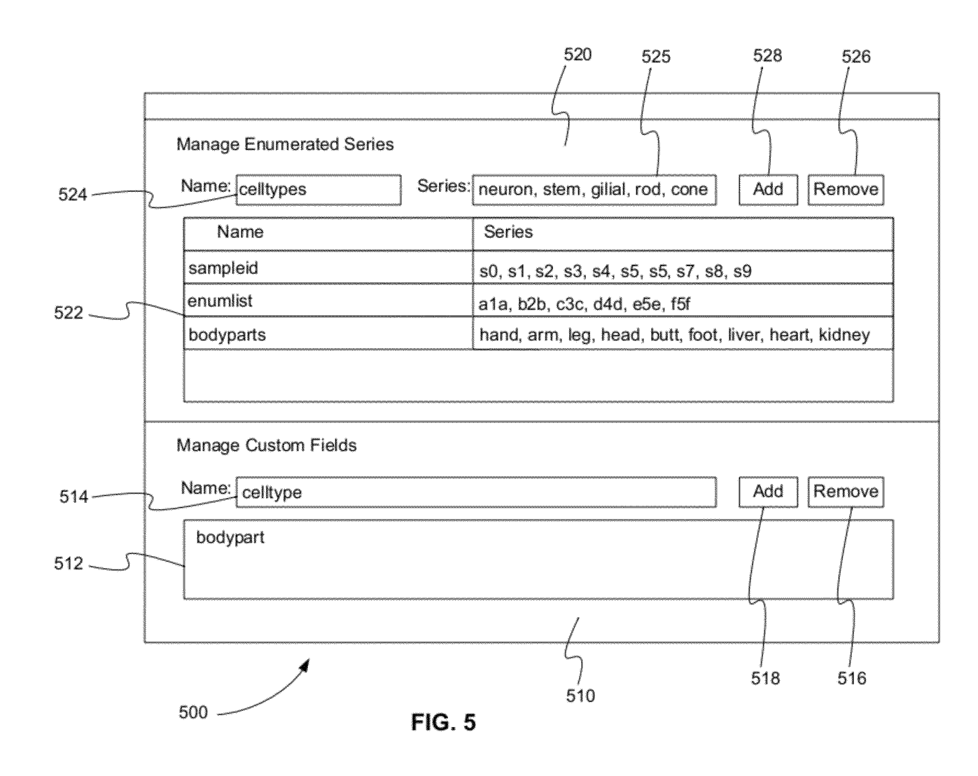

FIG. 5 is an exemplary popup window 500 of a GUI for adding custom attributes and defining enumerated series, in accordance with various embodiments. Window 500 includes custom attribute management area 510.

It should be recognized that, in various embodiments, adding custom attributes and defining enumerated series can be achieved by a user inputting attribute names and values directly into cells of a grid. In other embodiments, a user may select a cell and input attribute values by selecting an attribute type by cycling through the list of possible attributes and inputting the attribute value. In this way, a separate window, such as the exemplary popup window 500 of FIG. 5 is not needed in these embodiments.

According to various embodiments, custom attribute management area 510 may be used to add or remove custom attributes. Custom attribute text box 514 allows new custom attributes to be added. For example, new custom attribute “celltype” can be added by typing “celltype” in custom attribute text box 514 and clicking on add button 518. Custom attribute list box 512 shows the custom attributes already added. The custom attribute “bodypart” is shown in custom attribute list box 512, for example. Custom attribute “bodypart” can be removed by selecting “bodypart” in custom attribute list box 512 and clicking on remove button 516, for example.

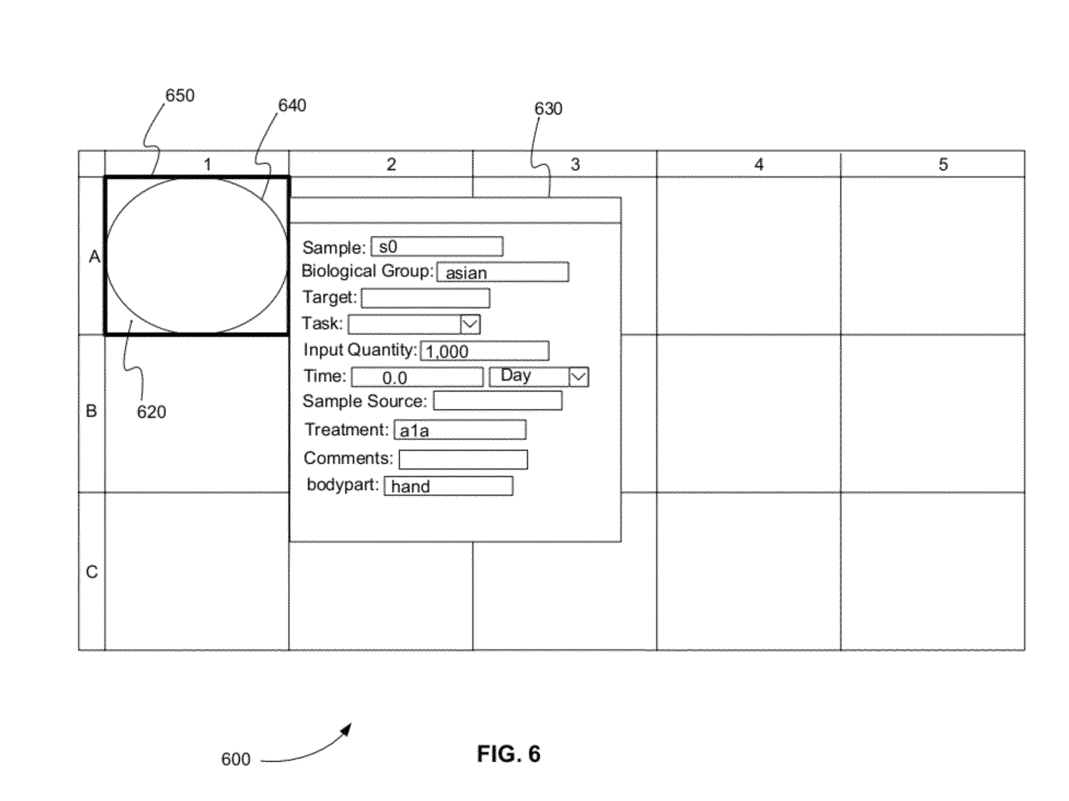

Window 500 also includes enumerated series management area 520. Enumerated series management area 520 is used to add or remove enumerated series. Enumerated series allow multiple attribute values to be assigned to multiple cells of the two-dimensional grid of cells of the GUI with one action, for example. Enumerated series name text box 524 and series text box 525 allow a new enumerated series and its values to be added. For example, the new enumerated series “celltypes” can be added by typing “celltypes” in the name text box 524, typing the series values in the series text box 525, and clicking on add button 528, for example. Enumerated series list box 522 shows the enumerated series names and values already added. The enumerated series “bodyparts” is shown in enumerated series list box 522, for example. Enumerated series “bodyparts” can be removed by selecting “bodyparts” in enumerated series list box 522 and clicking on remove button 526, for example. Noting the definition of the enumeration series “celltypes,” this series can be associated with the attribute “celltype” through, for example, the GUI shown in FIG. 6 if “celltype” were added to the attribute list as described above.

According to various embodiments, an enumerated series may be automatically suggested to the user based on commonly used series, for example. The suggested series may be extended to a plurality of cells. The suggested series may be previewed to the user. If a suggested series is not what the user desires, the user may edit the suggested series to the series the user desires. In some embodiments, attribute values defined for one cell may be used to fill in a plurality of cells unless a user inputs a different value or values for the plurality of cells. For example, a user may enter in an attribute value for one cell and the value would be automatically entered for all or some of the other cells. In other words, as a user begins typing a value, the value may be dynamically inputted to other cells in response to the user input of the value.

Further, in some embodiments, an attribute may be suggested to the user based on a type of character input by the user. For example, a user may enter a numerical value and attribute types requiring numerical values may be suggested to the user.

FIG. 6 is an exemplary portion of a two-dimensional grid of cells 600 of a GUI of a system representing a two-dimensional grid of sample wells and showing how multiple attribute values are assigned to a cell 620, in accordance with various embodiments. Cell 620 located at row and column A1 in two-dimensional grid of cells 600 is selected by clicking in cell 620, for example. Circle 640 and border 650 show that cell 620 is selected. Cell attribute popup worksheet 630 can be activated by clicking a mouse or keyboard button while cell 620 is selected, for example. Worksheet 630 shows attribute values being assigned to the attributes “Sample”, “Biological Group”, “Input Quantity”, “Time”, “Time Unit”, “Treatment,” and “bodypart.”

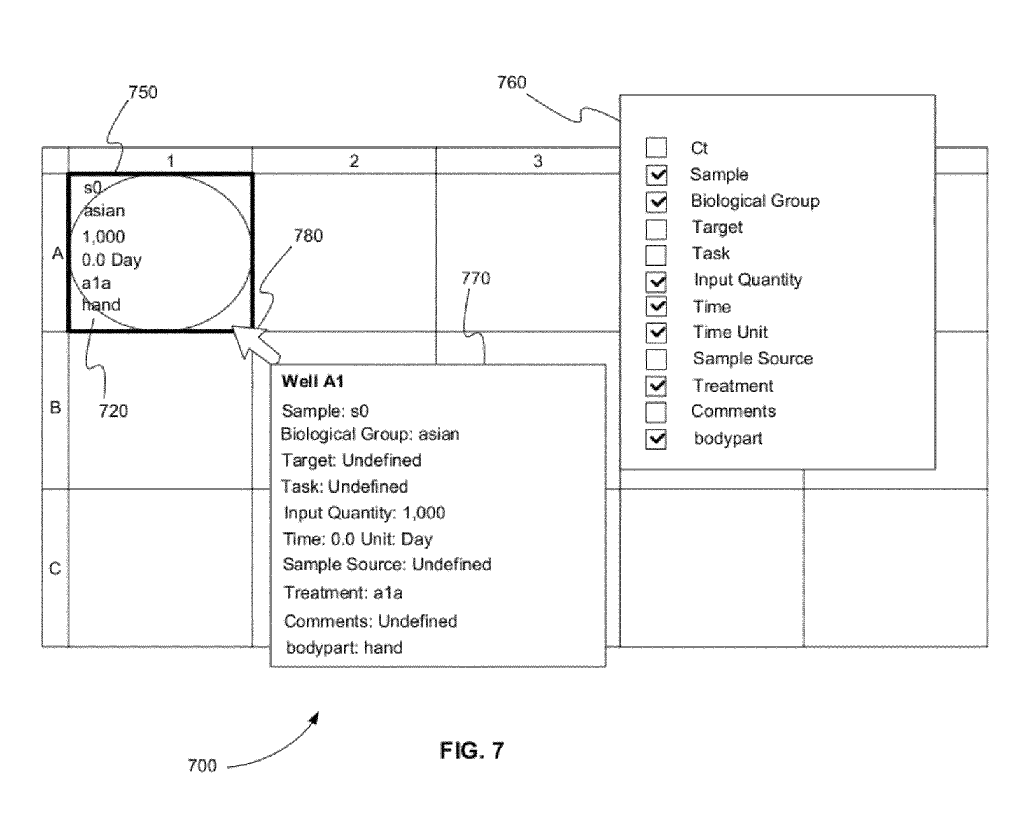

FIG. 7 is an exemplary portion of a two-dimensional grid of cells 700 of a GUI of a system representing a two-dimensional grid of plate wells and showing multiple attribute values for a cell 720, in accordance with various embodiments. The attribute values shown in cell 720 can alternatively be shown or not shown in the cells through the use of pull down menu 760, for example. As mentioned above, border 750 indicates that cell 720 located at row and column A1 is currently selected, for example.

All attributes and attribute values of cell 720 can also be shown in popup window 770. Popup window 770 is activated by moving pointer 780 over cell 720, for example.

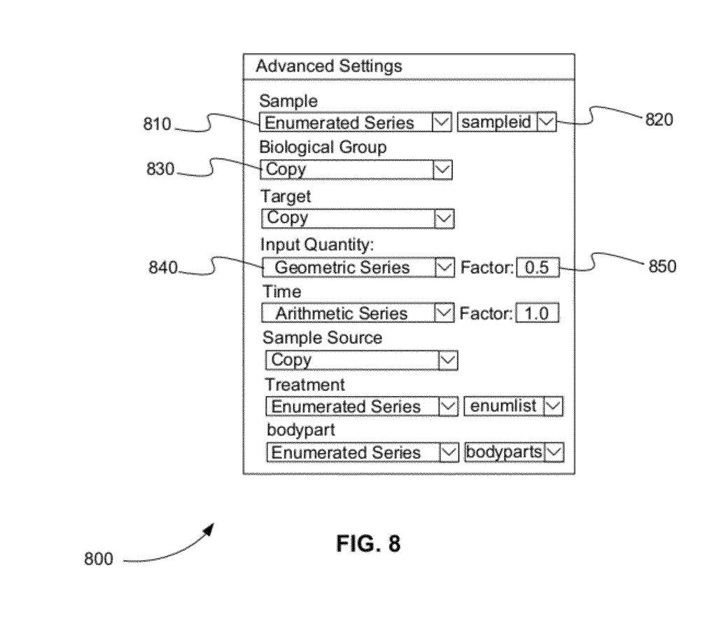

FIG. 8 is an exemplary worksheet window 800 of a GUI of a system for specifying advanced setting for attributes, in accordance with various embodiments. Worksheet 800 of FIG. 8 allows a user to specify how attribute values should be determined when an extension tool of the GUI is used. An extension tool of the GUI of the system allows the attribute values of one or more cells to be extended to one or more other cells. One method of extending attribute values is to copy them. Another method of extending attribute values is to set them according to a series. The type of series used can include, but is not limited to, a geometric series, an arithmetic series, or an enumerated series. Worksheet 800 allows a method of extending attribute values to be assigned to each attribute.

For example, the method of extending the “Sample” attribute is selected in field 810 to be an enumerated series and is selected to have the enumerated series values defined by the “sampleid” enumerated series in field 820. Extending the value for the “Sample” attribute from one grid cell to another would cycle through the values “s0,s1,s2, . . . , s9” (defined in FIG. 5) for the enumerated list “sampleid” in field 820. The method of extending the “Biological Group” attribute is selected in field 830 to be copy. Extending the value for the “Biological Group” attribute would simply copy the value from a selected grid cell into subsequent grid cells. The method of extending the “Input Quantity” attribute is selected in field 840 to be a geometric series with a factor of 0.5 as specified in field 850. Extending the value for the “Input Quantity” attribute assigned the value 100, for example, in a selected grid cell would load the successive values 100*0.5=50, 100*0.5*0.5=25, 100*0.5*0.5*0.5=12.5, etc. into subsequent grid cells. The method of extending the “Time” attribute in selected in field 860 to be an arithmetic series with a factor of 2.0 as specified in field 870. Extending the value for the time attribute assigned the value 5, for example, in a selected grid cell would load the successive values 5+1=6, 5+1+1=7, 5+1+1+1=8, etc. into subsequent grid cells.

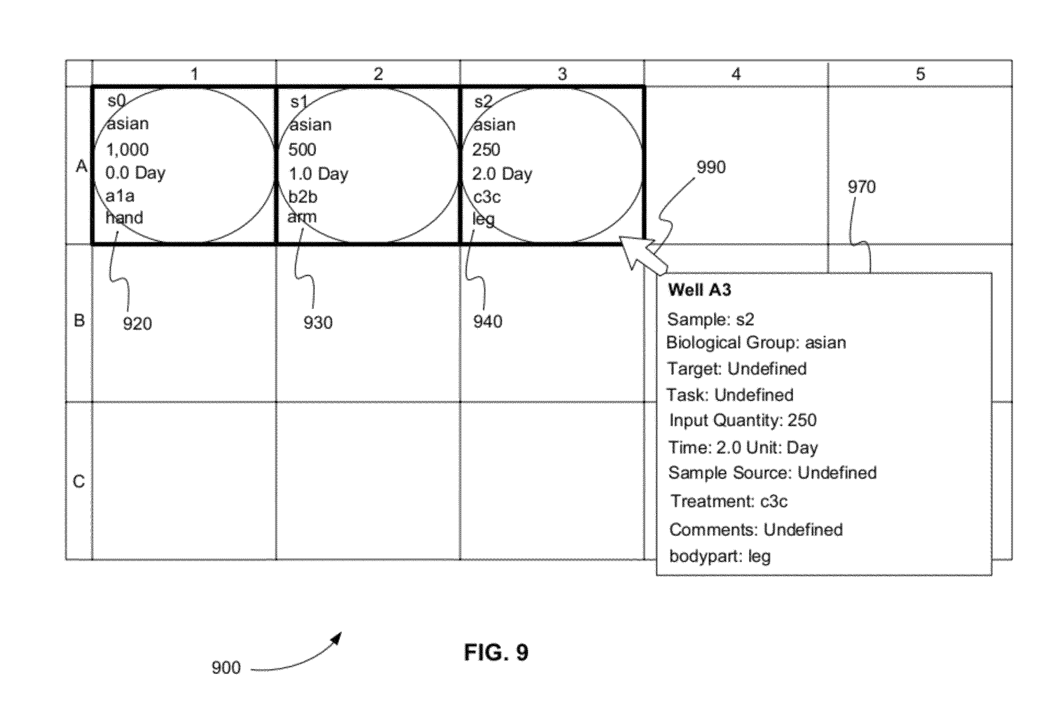

FIG. 9 is an exemplary portion of a two-dimensional grid of cells 900 of a GUI of a system representing a two-dimensional grid of plate wells and showing the extension of attribute values from one cell to two other adjacent cells in a row, in accordance with various embodiments. Cell 920 of two-dimensional grid of cells 900 located at row and column A1 shows seven attribute values as specified by checked pull down menu 760 of FIG. 7, for example. Values for these attributes were set using cell attribute popup worksheet 630 of FIG. 6, for example.

The seven attributes values of cell 920 in FIG. 9 are extended to cells 930 and 940 using an extension tool of the GUI of the system. The extension tool of the GUI of the system is the initial selection of cell 920 and the subsequent selection of cells 930 and 940 using the mouse or pointing device of the PCR system, for example. One skilled in the art can appreciate that input from a pointing device, a keyboard, any other input device, or any combination of input devices can be used to extend attribute values. One skilled in the art can also appreciate that attribute values can be extended from the initial selection of one or more cells to a subsequent one or more different cells, and the initial selection of one or more cells may or may not be adjacent to the subsequent one or more different cells.

Pointer 990 is shown over last selected cell 940. Pointer 990 activates popup window 970 that shows all attributes and attribute values of cell 940, for example.

Attribute values are extended from cell 920 to cells 930 and 940 according to the methods of extending attribute values specified in popup window 800 of FIG. 8, for example. In popup window 800, the “Sample” attribute is specified as extending according to the “sampleid” enumerated series. In FIG. 9, the “Sample” attribute value of cell 920 is set to “s0”. The “Sample” attribute values of cells 930 and 940 are extended to “s1” and “s2”, respectively.

In worksheet 800 of FIG. 8, the “Biological Group” attribute is specified as extending according to a copy function. In FIG. 9, the “Biological Group” attribute value of cell 920 is set to “asian”. The “Biological Group” attribute value “asian” is copied to “Biological Group” attribute values of cells 930 and 940.

In popup window 800 of FIG. 8, the “Input Quantity” attribute is specified as extending according to a geometric series with a factor of 0.5. In FIG. 9, the “Input Quantity” attribute value of cell 920 is set to 1,000. The “Input Quantity” attribute values of cells 930 and 940 are extended to 500 and 250, respectively.

In popup window 800 of FIG. 8, the “Time” attribute is specified as extending according to an arithmetic series with a factor of 1.0. In FIG. 9, the “Time” attribute value of cell 920 is set to 0.0. The “Time” attribute values of cells 930 and 940 are extended to 1.0 and 2.0, respectively.

In popup window 800 of FIG. 8, the “Treatment” attribute is specified as extending according to the enumlist enumerated series. In FIG. 9, the “Treatment” attribute value of cell 920 is set to “ala”. The “Treatment” attribute values of cells 930 and 940 are extended to “b2b” and “c2c”, respectively.

In popup window 800 of FIG. 8, the “bodypart” attribute is specified as extending according to the “bodyparts” enumerated series. In FIG. 9, the “bodypart” attribute value of cell 920 is set to “hand”. The “bodypart” attribute values of cells 930 and 940 are extended to “arm” and “leg”, respectively.

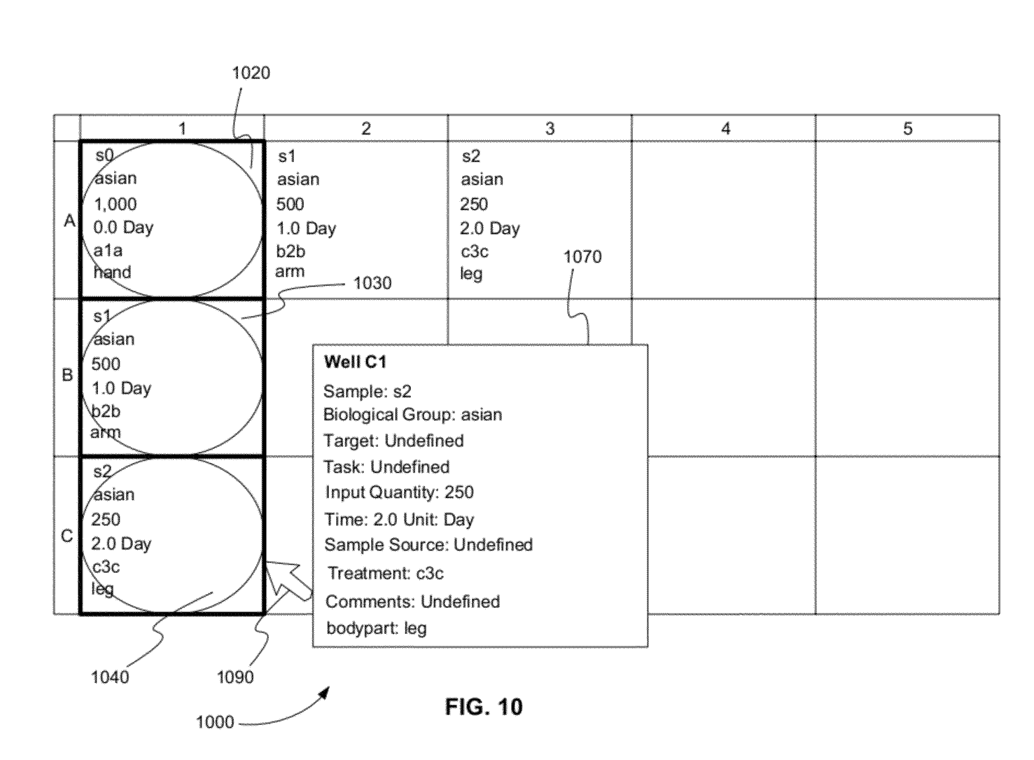

FIG. 10 is an exemplary portion of a two-dimensional grid of cells 1000 of a GUI of a system representing a two-dimensional grid of plate wells and showing the extension of attribute values from one cell to two other adjacent cells in a column, in accordance with various embodiments. Cell 1020 located at row and column A1 shows six attribute values. The six attributes values of cell 1020 are extended to adjacent column cells 1030 and 1040 using an extension tool of the GUI of the system. Pointer 1090 is shown over last selected cell 1040. Pointer 1090 activates popup window 1070 that shows all attributes and attribute values of cell 1040, for example.

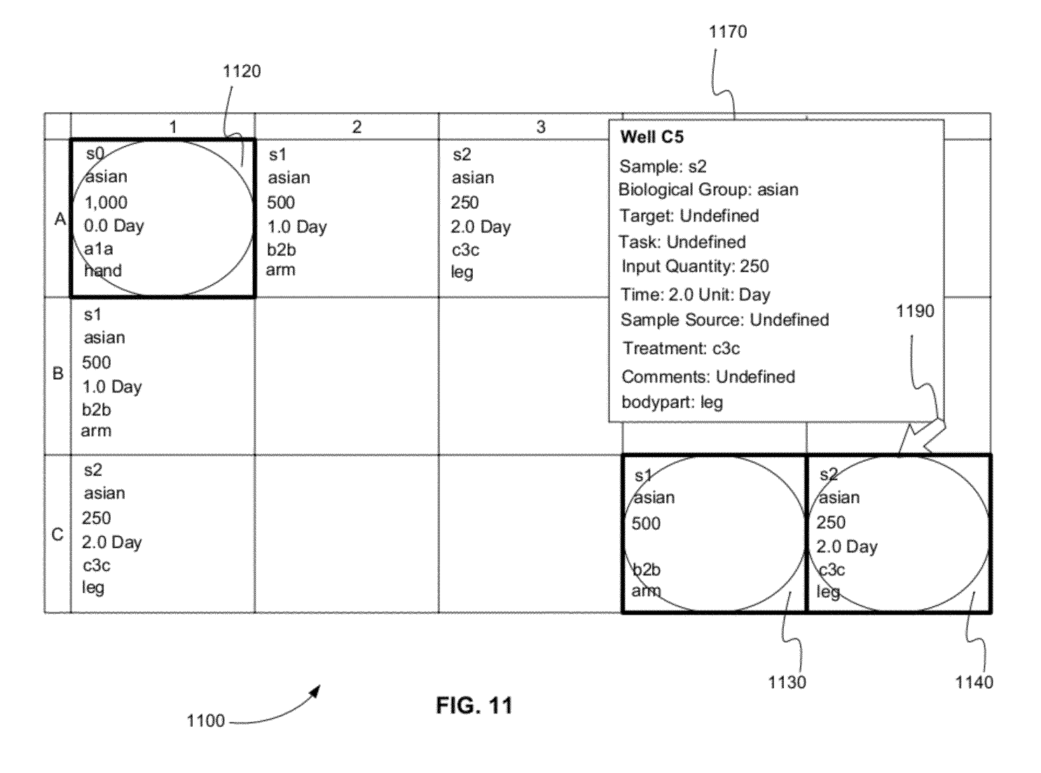

FIG. 11 is an exemplary portion of a two-dimensional grid of cells 1100 of a GUI of a system representing a two-dimensional grid of plate wells and showing the extension of attribute values from one cell to two other non adjacent cells in a row, in accordance with various embodiments. Cell 1120 located at row and column A1 shows six attribute values. The six attributes values of cell 1120 are extended to non adjacent row cells 1130 and 1140 using an extension tool of the GUI of the system. Pointer 1190 is shown over last selected cell 1140. Pointer 1190 activates popup window 1170 that shows all attributes and attribute values of cell 1140, for example.

FIGS. 9-11 show attribute values extended from one cell to one or many cells. In various embodiments, attribute values are extended from two or more cells to two more adjacent or non adjacent other cells. One skilled in the art can appreciate that the attribute values of two or more cells can be extended to any multiple or fraction of the two or more other cells.

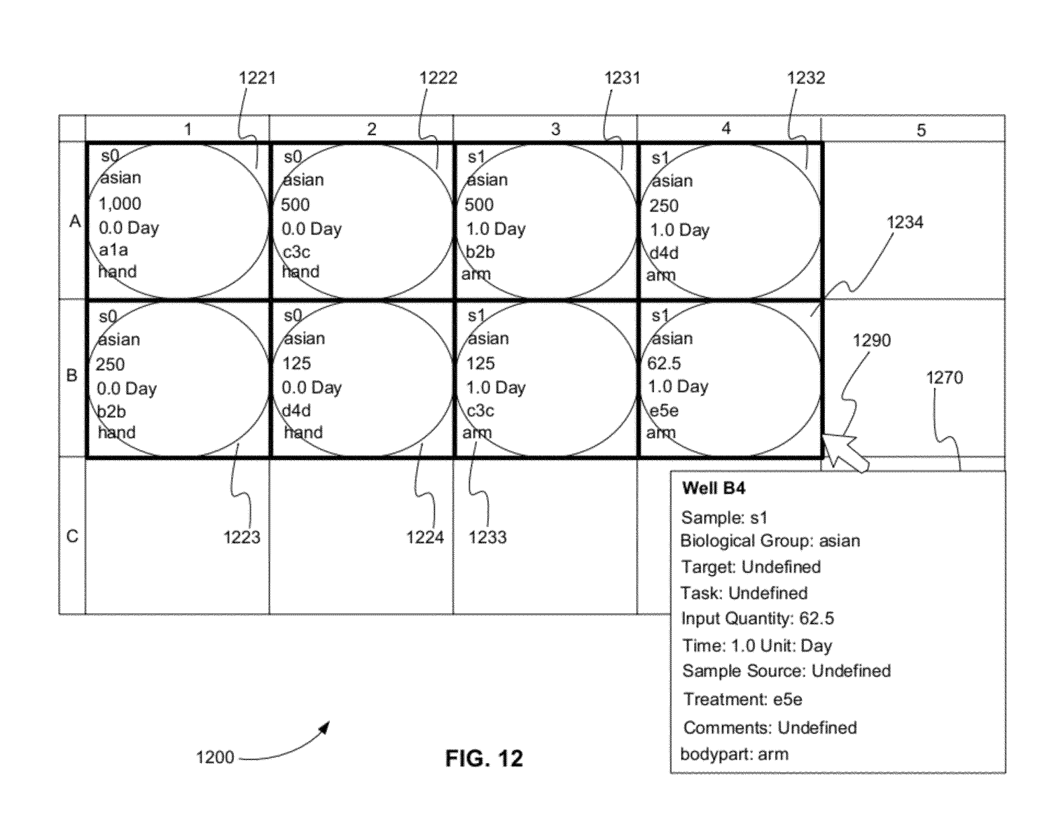

FIG. 12 is an exemplary portion of a two-dimensional grid of cells 1200 of a GUI of a system representing a two-dimensional grid of plate wells and showing the extension of attribute values from four cells to four other adjacent cells, in accordance with various embodiments. Cells 1221, 1222, 1223, and 1224 located at row and column locations A1, A2, B1, and B2, respectively, each show six attribute values. The six attributes values of cells 1221, 1222, 1223, and 1224 are extended to adjacent cells 1231, 1232, 1233, and 1234 located at row and column locations A3, A4, B3, and B4, respectively, using an extension tool of the GUI of the system. Pointer 1290 is shown over last selected cell 1234. Pointer 1290 activates popup window 1270 that shows all attributes and attribute values of cell 1234, for example.

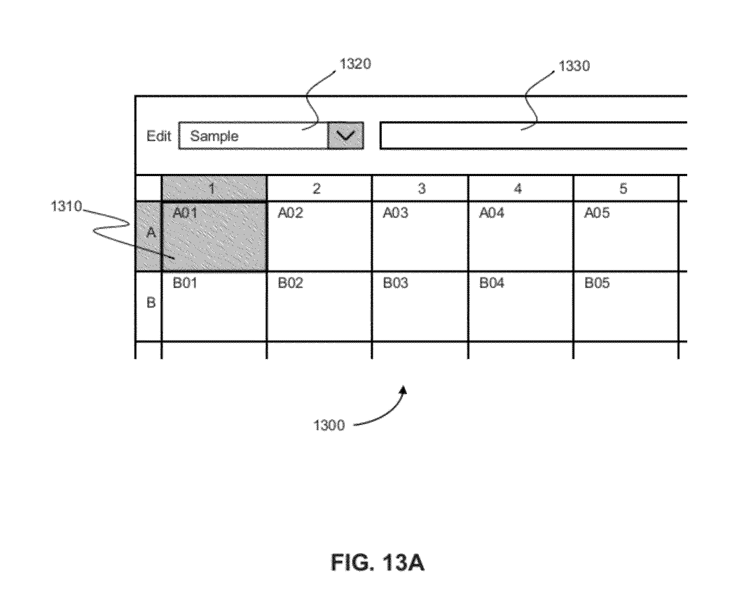

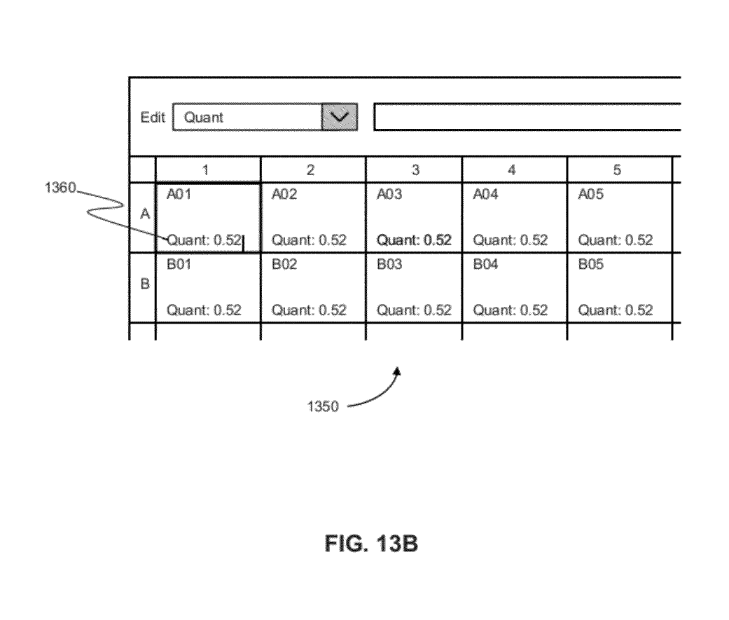

FIG. 13A illustrates an exemplary portion of a two-dimensional grid of cells 1300 of a GUI of a PCR system representing a two-dimensional grid of plate wells and showing the extension of attribute values from one cell to two other non adjacent cells in a row, in accordance with various embodiments.

According to various embodiments as illustrated in FIG. 13A, a user may select cell 1310 for entering in attribute values. In other embodiments, the user may select multiple cells for inputting the same attribute value in the selected multiple cells. In various embodiments, the user may type in the attribute type in field 1320 to define a new attribute type. If the user defines a new attribute type by typing in the name of the attribute type in field 1320, the same attribute type may be available upon selection of a different cell. On the other hand, the user may also select the type of attribute from predefined attribute types for which she wishes to enter a value, for example, from a drop down menu associated with field 1320. The name of the attribute type may be stored and provided to the user in a drop down menu. In this way, the value for the same attribute type may be input in for a different cell.

According to various embodiments, once the attribute type is selected in field 1320, the value may be entered in field 1330.

As mentioned above, with reference to FIG. 13B, attribute values may be entered directly in a cell representing a sample according to various embodiments. For example, a user may select a cell 1360. In response, a cursor may appear in cell 1360 and the user may input attribute values for the sample contained in the well corresponding to cell 1360 directly into the cell. In some embodiments, the user may enter in the same attribute values in the selected cells at one time as illustrated in the grid of cells 1350. The user may enter in 0.52 as shown in cell 1360 for a quantity attribute. As the user types the attribute value, the same attribute value may be input for all, selected cells, a row, or a column, for example, of the cells 1350. As such, attribute values for a plurality of samples may be entered in quickly and efficiently.

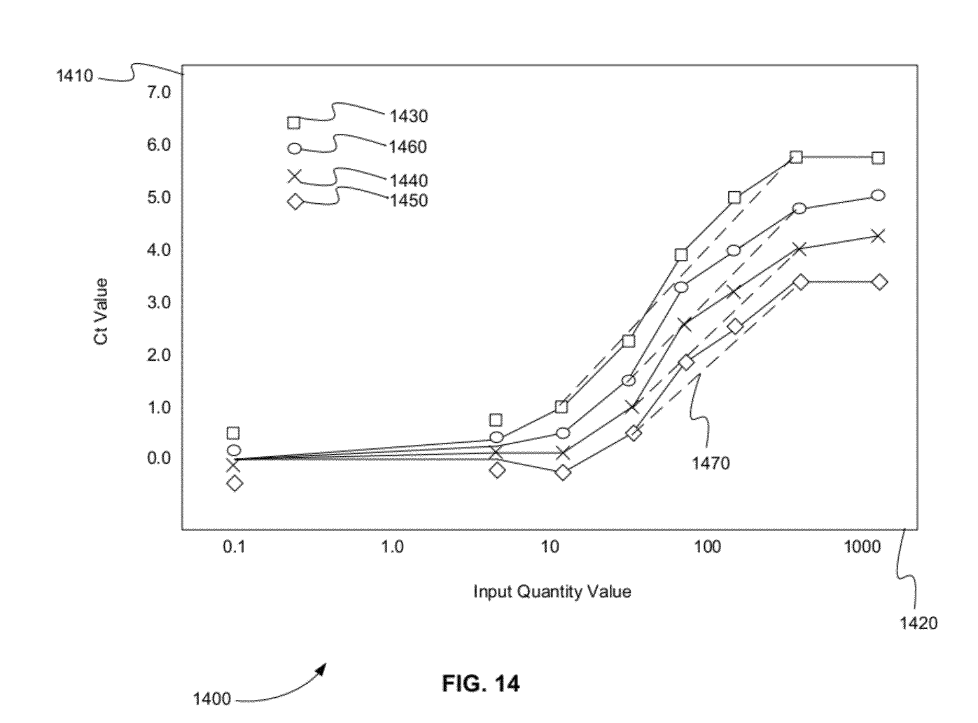

The methods used to assign attributes and their values as shown in FIGS. 4-13 can be used to assign and extend attribute values to all cells that include an experimental value. As described above, these attribute values and the corresponding experimental values can be used to further analyze the experiment. For example, plots to analyze the data may be generated based on attribute type as illustrated in FIG. 14.

FIG. 14 is an exemplary plot 1400 of experimental average cycle threshold (Ct) values 1410 plotted as a function of “Input Quantity” attribute values 1420, in accordance with various embodiments. Ct values 1410 are plotted as a function of “Input Quantity” attribute values 1420 for samples 1430, 1440, 1450, and 1460. Samples 1430, 1440, 1450, and 1460 are determined by the “Sample” attribute, for example. Dotted lines 1470 are linear regression results within an interval of the data considered to be linear. The parameters of lines 1470, namely slope and intercept, are used to estimate fold change values, for example. Fold change is a measure of the quantity of a substance of interest in an unknown sample relative to a reference sample, for example. Designating unknown and reference samples can be done using the “Task” attribute, for example.

### Systems and Methods for Assigning Attributes to a Plurality of Samples

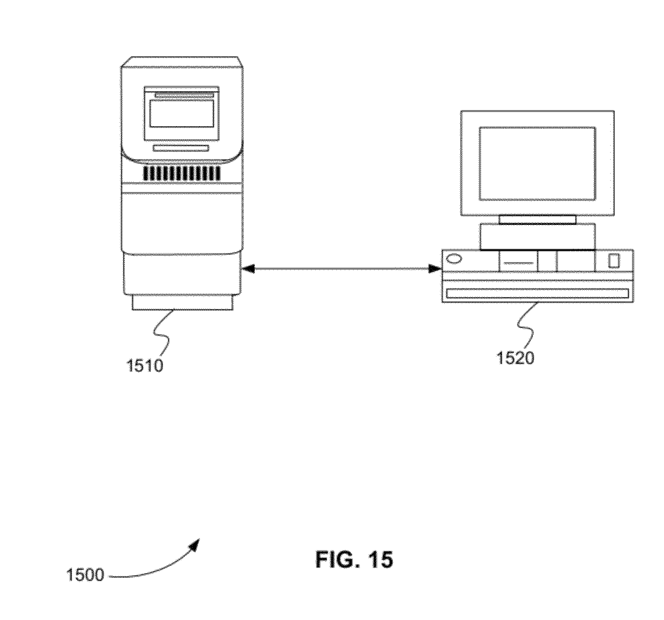

FIG. 15 illustrates a system 1500 for assigning attributes, in accordance with various embodiments. There may be other configurations of a system according to other embodiments described herein. System 1500 includes instrument 1510 and computer system 1520. Computer system 1520 may be computing system 100 as shown in FIG. 1 in some embodiments. Instrument 1510 and computer system 1520 are in communication. This communication can include the exchange of data or control information, for example. In some embodiments, instrument 1510 is a real-time PCR instrument. As such, for example, instrument 1510 may perform a PCR experiment on multiple samples in a multi-well sample support device (not shown) and produces a plurality of measured values.

Computer system 1520 performs a number of steps. Computer system 1520 receives the plurality of measured values from instrument 1510. Computer system 1520 stores the plurality of measured values in a memory (not shown) configured as a two-dimensional grid of cells representing the two-dimensional grid of the multi-well sample support device. The memory can be a memory of computer system 1520, a memory of instrument 1510, or a memory external to computer system 1520, for example. Computer system 1520 displays the two-dimensional grid of cells in a graphical user interface (GUI). Computer system 1520 receives a selected cell from the GUI and displays a window in the GUI allowing one or more attribute values to be assigned to the selected cell. Computer system 1520 receives one or more values to assign to one or more attributes associated with the selected cell from the GUI. Finally, computer system 1520 stores the one or more assigned attribute values along with a measured value of the selected cell in the memory configured as a two-dimensional grid of cells.

In various embodiments, computer system 1520 displays a window in the GUI allowing one or more custom attributes to be added or removed.

In various embodiments, computer system 1520 displays a window in the GUI allowing enumerated series and series values to be added or removed.

In various embodiments, computer system 1520 displays one or more attribute values and the measured value of the selected cell in a depiction of the selected cell in the displayed two-dimensional grid of cells in a GUI.

In various embodiments, computer system 1520 displays a window in the GUI allowing a method of extending one or more attributes to one or more additionally selected cells and receives a selected method for at least one attribute. Computer system 1520 receives one or more additionally selected cells from the GUI and assigns values for at least one attribute to each of one or more additionally selected cells according to the selected method. The selected method includes, but is not limited to, a copy function, an enumerated series, a geometric series, or an arithmetic series.

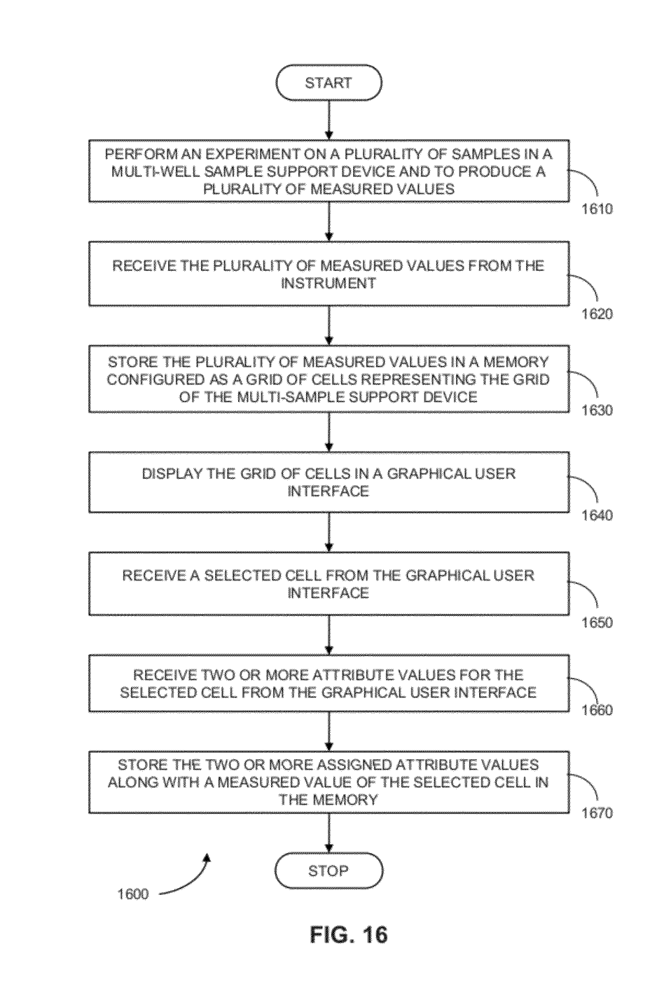

FIG. 16 is an exemplary flowchart showing a method 1600 for assigning attributes to a plurality of samples, in accordance with various embodiments. The processor 104 shown in FIG. 1 may perform method 1600 by executing instructions stored on a computer-readable medium, in various embodiments.

In step 1610 of method 1600, an experiment is performed on multiple samples in a multi-sample support device and a plurality of measured values is produced using an instrument.

In step 1620, the plurality of measured values is received from the instrument using a computer system.

In step 1630, the plurality of measured values is stored in a memory configured as a grid of cells representing the grid of the multi-sample support device using the computer system.

In step 1640, the two-dimensional grid of cells is displayed in a graphical user interface (GUI) using the computer system.

In step 1650, a selected cell is received from the GUI and a window is displayed in the GUI allowing one or more attribute values to be assigned to the selected cell using the computer system.

In step 1660, one or more values to assign to one or more attributes associated with the selected cell are received from the GUI using the computer system.

In step 1670, the one or more assigned attribute values are stored along with a measured value of the selected cell in the memory configured as a grid of cells using the computer system.

In various embodiments, a computer program product includes a tangible computer-readable storage medium whose contents include a program with instructions being executed on a processor so as to perform the method for assigning attributes to a plurality of samples. This method is performed by a system of distinct software modules.

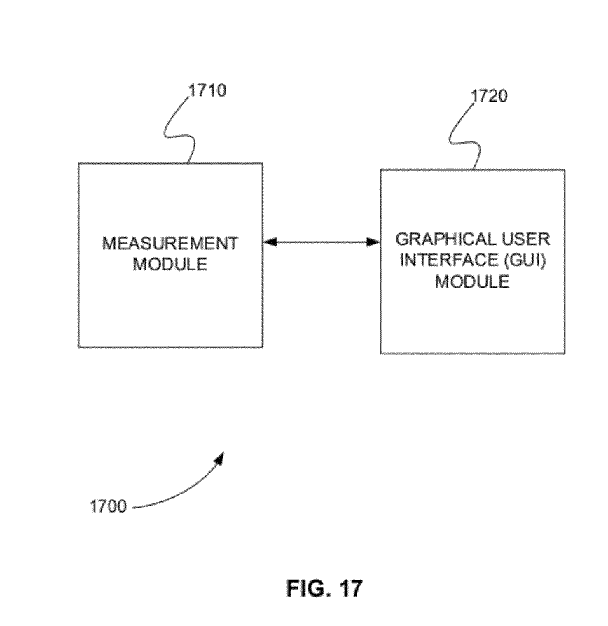

FIG. 17 is a schematic diagram of a system 1700 of distinct software modules that performs a method for assigning attributes, in accordance with various embodiments. System 1700 includes measurement module 1710, and graphical user interface (GUI) module 1720. Measurement module 1710 receives a plurality of measured values from an instrument that performs an experiment.

GUI module 1720 performs a number of steps. GUI module 1720 stores the plurality of measured values in a memory configured as a two-dimensional grid of cells representing the two-dimensional grid of the multi-sample support device. GUI module 1720 displaying the two-dimensional grid of cells in a GUI. GUI module 1720 receives a selected cell from the GUI and displays a window in the GUI allowing one or more attribute values to be assigned to the selected cell. GUI module 1720 receives one or more values to assign to one or more attributes associated with the selected cell from the GUI. Finally, GUI module 1720 stores the one or more assigned attribute values along with a measured value of the selected cell in the memory configured as a two-dimensional grid of cells.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for assigning attributes to a plurality of samples, the system comprising:
an instrument configured to perform an experiment on a plurality of samples in a multi-well sample support device and to produce a plurality of measured values; and
a computer system in communication with the instrument and configured to:
receive the plurality of measured values from the instrument,
store the plurality of measured values in a memory configured as a grid of cells representing the grid of the multi-sample support device,
display the grid of cells in a graphical user interface,
receive a selected cell from the graphical user interface,
receive two or more attribute values for the selected cell from the graphical user interface, and
store the two or more assigned attribute values along with a measured value of the selected cell in the memory.

2. The system of claim 1, wherein the computer system is configured to receive two or more attribute values from input by a user into the selected cell.

3. The system of claim 1, wherein the computer system is further configured to display a window in the graphical user interface allowing one or more custom attributes to be added or removed.

4. The system of claim 1, wherein the computer system is configured to further display a window in the graphical user interface allowing enumerated series and series values to be added or removed.

5. The system of claim 1, wherein the computer system is further configured to display one or more attribute values and the measured value of the selected cell in a depiction of the selected cell in the displayed grid of cells in a graphical user interface.

6. The system of claim 1, wherein the computer system is further configured to dynamically assign the two or more attribute values received for the selected cell to at least one other cell of the grid of cells.

7. The system of claim 1, wherein the computer system is further configured to dynamically assign an attribute value based on the at least one of the two or more attribute values received for the selected cell to at least one other cell of the grid of cells.

8. The system of claim 7, wherein the computer system is further configured to dynamically assign based on the at least one of the two or more attribute values using at least one method from the group consisting of: a copy, an enumerated series, a geometric series, and an arithmetic series.

9. A computer-implemented method for assigning attributes to a plurality of samples, the computer-implemented method comprising:
performing an experiment on a plurality of samples in a multi-sample support device and producing a plurality of measured values using an instrument;
receiving the plurality of measured values from the instrument;
storing the plurality of measured values in a memory configured as a grid of cells representing the grid of the multi-well sample support device;
displaying the grid of cells in a graphical user interface;
receiving a selected cell from the graphical user interface;
receiving two or more attribute values for the selected cell from the graphical user interface; and
storing the two or more assigned attribute values along with a measured value of the selected cell in the memory configured as a grid of cells.

10. The computer-implemented method of claim 9, further comprising displaying a window in the graphical user interface allowing one or more custom attributes to be added or removed.

11. The computer-implemented method of claim 9, further comprising displaying a window in the graphical user interface allowing enumerated series and series values to be added or removed.

12. The computer-implemented method of claim 9, further comprising displaying one or more attribute values and the measured value of the selected cell in a depiction of the selected cell in the displayed grid of cells in a graphical user interface.

13. The computer-implemented method of claim 9, further comprising displaying a window in the graphical user interface allowing a method of assigning one or more attributes to one or more additional cells and receives a selected method of value assignment for at least one attribute included in the grid of cells.

14. The computer-implemented method of claim 13, further comprising receiving one or more additionally selected cells from the graphical user interface and assigning values for the at least one attribute to each of one or more additionally selected cells according to the selected method of value assignment.

15. The computer-implemented method of claim 13, wherein the selected method of value assignment comprises at least one method from the group consisting of: a copy, an enumerated series, a geometric series, and an arithmetic series.

16. A computer-readable storage medium encoded with instructions, executable by a processor, for assigning attributes to a plurality of samples using an instrument, the instructions comprising instructions for:
receiving a plurality of measured values from an instrument, wherein the instrument is configured to perform an experiment on a plurality of samples in a multi-sample support device to produce the plurality of measured values;
storing the plurality of measured values in a memory configured as a grid of cells representing the grid of the multi-sample support device,
displaying the grid of cells in a graphical user interface,
receiving a selected cell from the graphical user interface,
receiving two or more attribute values for the selected cell from the graphical user interface, and
storing the two or more assigned attribute values along with a measured value of the selected cell in the memory configured as a grid of cells.

17. The computer program product of claim 16, wherein the instructions further comprise instructions for displaying one or more attribute values and the measured value of the selected cell in a depiction of the selected cell in the displayed grid of cells in a graphical user interface.

18. The computer program product of claim 16, wherein the instructions further comprise instructions for displaying a window in the graphical user interface allowing a method of assigning one or more attributes to one or more additional cells and receives a selected method of value assignment for at least one attribute included in the grid of cells.

19. The computer program product of claim 17, wherein the instructions further comprise instructions for receiving one or more additionally selected cells from the graphical user interface and assigning values for the at least one attribute to each of one or more additionally selected cells according to the selected method of value assignment.

20. The computer program product of claim 17, wherein the selected method of value assignment comprises at least one method from the group consisting of: a copy, an enumerated series, a geometric series, and an arithmetic series.
